(19) United States
(12) Patent Application Publication
(10) Pub. No.: US 2024/0356701 A1
(43) Pub. Date: Oct. 24, 2024

(54) METHOD FOR PILOT ALLOCATION USING HUNGARIAN ALGORITHM IN CELL-FREE MASSIVE MIMO SYSTEM

(71) Applicant: ELECTRONICS AND TELECOMMUNICATIONS RESEARCH INSTITUTE, Daejeon (KR)

(72) Inventors: Se Young CHO, Daejeon (KR); Seung Eun Hong, Daejeon (KR); Jee Hyeon Na, Daejeon (KR)

(21) Appl. No.: 18/637,822

(22) Filed: Apr. 17, 2024

(30) Foreign Application Priority Data
Apr. 18, 2023 (KR) 10-2023-0050514

(51) Int. Cl. H04L 5/00; H04B 7/0452; H04W 48/20

(52) U.S. Cl. CPC H04L 5/005; H04B 7/0452; H04W 48/20

(57) ABSTRACT

The present disclosure provides a method for pilot allocation using the Hungarian algorithm in a cell-free massive MIMO system. The method includes obtaining a first matrix by computing a large-scale channel gain between each of a plurality of UEs and each of a plurality of APs included in the cell-free massive MIMO system; assigning each of the plurality of UEs to a first group or a second group by using the first matrix; allocating a pilot to each UE in the second group; obtaining a second matrix by computing the reusability of pilots between each UE in the first group and each UE in the second group; and allocating a pilot to each UE in the first group by applying the Hungarian algorithm to the second matrix.

### CROSS-REFERENCE TO RELATED APPLICATIONS

This application is based on, and claims priority to, Korean Patent Application Number 10-2023-0050514, filed on Apr. 18, 2023, the disclosure of which is incorporated by reference herein in its entirety.

### TECHNICAL FIELD

The present disclosure relates to a method for pilot allocation using the Hungarian algorithm in a cell-free massive MIMO system.

### BACKGROUND

The statement herein merely provides background information related to the present disclosure and may not necessarily constitute the prior art.

A cell-free massive MIMO system is a technology that allows a single CPU to provide service to an individual user through collaborations between ultra-densely distributed APs by dividing an mMIMO antenna array located at the center of a cell into a plurality of access points (APs) having fewer antennas and arbitrarily distributing them in a cell area, assigning low-level functions of a baseband to the ultra-densely distributed APs in a given area including a plurality of cells, and connecting the APs to the single central processing unit (CPU) via a fronthaul link. In the system, channel state information (CSI) may be acquired through transmitting pilot signals between a user and an AP. However, lack of sufficient orthogonal pilot sequences due to natural channel variations in the time and frequency domains forces the user into reusing pilot resources, causing pilot contamination.

There was proposed a method in which the number of users serviced by a single AP is limited to the number τₚ of orthogonal pilot sequences to allocate orthogonal pilots to τₚ users, and a master AP for each user is selected to allocate co-pilots in order to minimize pilot interference from the perspective of the AP. However, this method does not take into account interference with users who have not yet been assigned co-pilots in the step of repeatedly allocating co-pilots, and users who are ranked low in terms of pilot allocation may experience a degradation in performance.

Therefore, there arises a need for a method for pilot allocation capable of solving the above-mentioned problems.

### SUMMARY

Embodiments of the present disclosure provide a method for pilot allocation capable of minimizing interference between users.

Embodiments of the present disclosure provide a method of allocating an optimum pilot to each user by computing pilot reusability based on a large-scale channel gain between each user and each AP and using it as a weighted input for the Hungarian algorithm.

The purposes of the present disclosure are not limited to those mentioned above, and other purposes not mentioned herein will be clearly understood by those skilled in the art from the following description.

According to at least one embodiment, the present disclosure provides a method for allocating pilots by using the Hungarian algorithm in a cell-free massive MIMO system. The method includes obtaining a first matrix by computing a large-scale channel gain between each of a plurality of UEs and each of a plurality of APs included in the cell-free massive MIMO system; assigning each of the plurality of UEs to a first group or a second group by using the first matrix; allocating a pilot to each UE in the second group; obtaining a second matrix by computing the reusability of pilots between each UE in the first group and each UE in the second group; and allocating a pilot to each UE in the first group by applying the Hungarian algorithm to the second matrix.

According to another embodiment, the present disclosure provides a computer-readable recording medium with instructions stored therein, wherein the instructions, when executed by the computer, cause the computer to implement a method including obtaining a first matrix by computing a large-scale channel gain between each of a plurality of UEs and each of a plurality of APs included in the cell-free massive MIMO system; assigning each of the plurality of UEs to a first group or a second group by using the first matrix; allocating a pilot to each UE in the second group; obtaining a second matrix by computing the reusability of pilots between each UE in the first group and each UE in the second group; and allocating a pilot to each UE in the first group by applying the Hungarian algorithm to the second matrix.

According to an embodiment of the present disclosure, a cell-free massive MIMO system is able to provide better performance under the same environment, compared to the conventional art, simply by making a difference in the pilot allocation method.

The effects of the present disclosure are not limited to the effects mentioned above, and other effects not mentioned will be clearly understood by those skilled in the art from the description below.

### BRIEF DESCRIPTION OF THE DRAWINGS

FIG. 1 is a conceptual diagram showing an embodiment of a typical cell-free massive MIMO system.

FIG. 2 is a flow chart of a method for pilot allocation according to an embodiment of the present disclosure.

FIG. 3 is a diagram showing a large-scale channel gain matrix between each UE and each AP according to an embodiment of the present disclosure.

### DETAILED DESCRIPTION

Hereinafter, some embodiments of the present disclosure will be described in detail with reference to the accompanying illustrative drawings. In the following description, like reference numerals preferably designate like elements, although the elements are shown in different drawings. Further, in the following description of some embodiments, a detailed description of related known components and functions when considered to obscure the subject of the present disclosure will be omitted for the purpose of clarity and for brevity.

Various ordinal numbers or alpha codes such as first, second, i), ii), a), b), etc., are prefixed solely to differentiate one component from the other but not to imply or suggest the substances, order, or sequence of the components. Throughout this specification, when a part “includes” or “comprises” a component, the part is meant to further include other components, not to exclude thereof unless specifically stated to the contrary. The terms such as “unit,” “module,” and the like refer to one or more units for processing at least one function or operation, which may be implemented by hardware, software, or a combination thereof.

The description of the present disclosure to be presented below in conjunction with the accompanying drawings is intended to describe exemplary embodiments of the present disclosure and is not intended to represent the only embodiments in which the technical idea of the present disclosure may be practiced.

A cell-free massive MIMO system will be described as a communication system to which embodiments according to the present disclosure are applied. The communication system to which the embodiments according to the present disclosure are applied is not limited to what will be described hereinbelow, and the embodiments of the present disclosure may be applied to various communication systems. As used herein, the term “communication system” may have the same meaning as “communication network”.

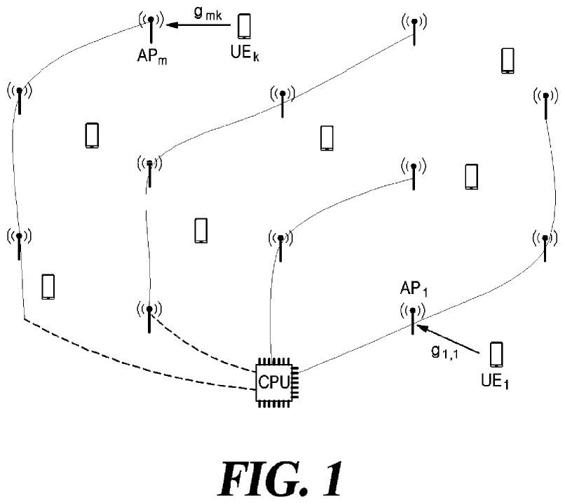

FIG. 1 is a conceptual diagram showing an embodiment of a typical cell-free massive MIMO system (hereinafter, “CF mMIMO system”). The typical CF mMIMO system may include one or more central processing units (CPUs), a plurality of distributed APs, and a plurality of UEs.

Referring to FIG. 1, a central processing unit (CPU) provides service to each of K UEs through collaborations between M geographically distributed APs. As used herein, APₘ denotes an m-th AP, UEₖ denotes a k-th UE, and gₘₖ denotes a channel gain between the m-th AP and the k-th UE.

The central processing unit (CPU) may perform high-level functions (e.g., L2 function and/or L3 function) and/or physical layer functions of a base station or baseband. The central processing unit may determine and allocate a UE's pilot information or pilot sequence based on channel state information between each AP and each UE. The central processing unit may transmit pilot sequence allocation information to the UEs. The central processing unit (CPU) and the APs may be interconnected via a wired and/or wireless fronthaul link. Also, the central processing unit (CPU) may be connected to a core network (not shown) via a backhaul link.

The APs may perform low-level functions (e.g., RF function) and/or physical layer function of the baseband.

Each of the plurality of UEs may refer to UE (user equipment), TE (terminal equipment), an AMS (advanced mobile station), an HR-MS (high reliability-mobile station), a terminal, an access terminal, a mobile terminal, a station, a subscriber station, a mobile station, a portable subscriber station, a node, a device, an OBU (on board unit), a user, etc.

Meanwhile, the pilot contamination effect is an interference problem that appears when a non-orthogonal pilot sequence is used, which lowers the accuracy of channel estimation and therefore degrades service quality (QOS). The pilot contamination effect may refer to the problem of limiting communication efficiency which occurs when there are different users sharing the same pilot signal.

The present disclosure relates to providing a method of improving communication efficiency by taking into account even interference with users who are ranked low in terms of pilot allocation in the reuse of pilots or the allocation of co-pilots.

In this specification, the term “pilot” may be used interchangeably with “pilot signal”, “pilot sequence”, or “reference signal”.

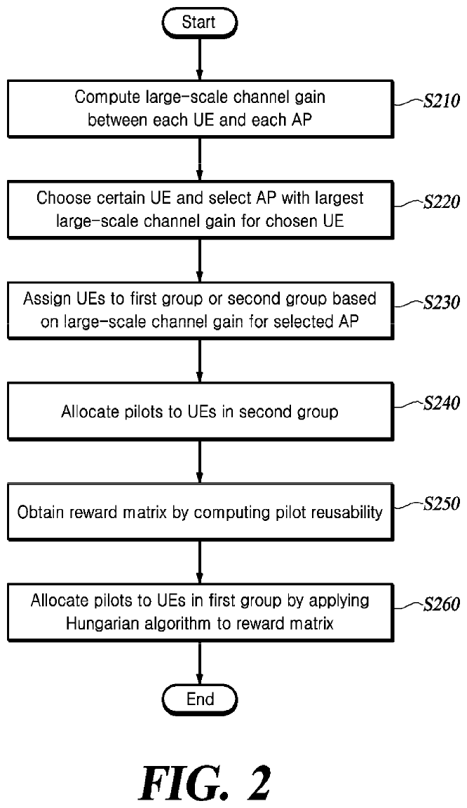

FIG. 2 is a flow chart of a method for pilot allocation according to an embodiment of the present disclosure.

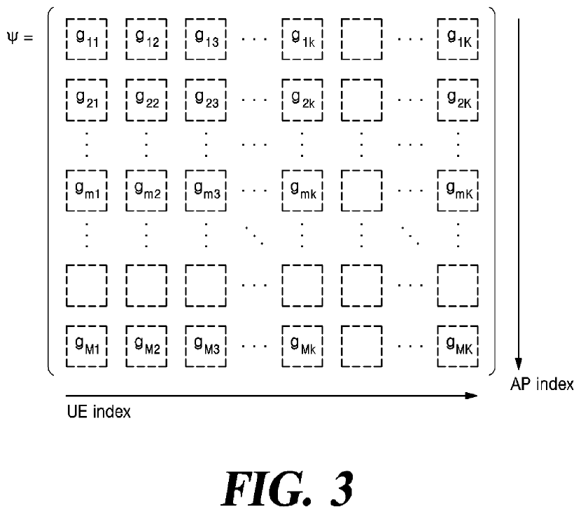

Referring to FIG. 2, a large-scale channel gain between each of a plurality of UEs and each of a plurality of APs constituting a CF mMIMO system is computed (S210). Here, the large-scale channel gain may be a value computed by taking path loss and shading into account. The large-scale channel gain may be a value computed by taking noise power into account. The large-scale channel gain may be represented by a large-scale channel gain matrix Ψ, as shown in FIG. 3.

Pilots are allocated first to low-ranked terminals by using the computed large-scale channel gain matrix Ψ, and the reusability of pilots between low-ranked UEs and high-ranked UEs is computed. Here, the term “pilot reusability” may refer to a metric that represents how much interference caused by co-pilot allocation can be minimized.

Specifically, a certain UE is chosen, and an AP with the largest large-scale channel gain is selected for the chosen UE (S220). The UEs are sorted in descending order according to large-scale channel gain based on the selected AP, a high-ranked group is formed in such a way as to contain as many UEs as the maximum number τₚ of orthogonal pilot sequence resources, including the chosen UE, in the order of largest to smallest large-scale channel gain, and a low-ranked group is formed in such a way as to contain the other UEs not included in the high-ranked group (S230). Orthogonal pilot sequences are sequentially allocated to the UEs constituting the low-ranked group (S240).

A reward matrix is formulated by computing the reusability of pilots between the UEs constituting the high-ranked group and the UEs constituting the low-ranked group (S250). For example, an AP with the largest large-scale channel gain may be found for each UE included in the high-ranked group, and the pilot reusability may be computed for that AP, based on a difference in large-scale channel gain between the corresponding UE and each UE included in the low-ranked group. It can be determined that the higher the pilot reusability, the smaller the pilot contamination effect, and the lower the pilot reusability, the greater the pilot contamination effect. A reward matrix may be formulated that represents the problem of finding maximum gain or reward for allocating co-pilots based on the computed pilot reusability.

The Hungarian algorithm may be applied to the reward matrix to find an optimal co-pilot for each UE constituting the high-ranked group and allocate it to the UE (S260). Specifically, for each UE in the high-ranked group in the reward matrix, a UE with the highest pilot reusability in the low-ranked group is matched with the corresponding UE in the high-ranked group, and the same pilot sequence as that of the matched UE in the low-ranked group is allocated to the corresponding UE in the high-ranked group. The Hungarian algorithm is used to solve the problem of weight matching in a bipartite graph and has a polynomial time complexity. The Hungarian algorithm represents the assignment problem in a matrix or a bipartite graph to find a maximum-reward matching or a minimum-cost matching.

For ease of explanation, an optimal co-pilot allocation is found under the assumption that a large-scale channel gain matrix computed between four UEs and eight APs is given by Equation 1. In this case, let the maximum number τₚ of orthogonal pilot sequence resources be 2 (e.g., 0, 1).

$$Ψ = [ \begin{matrix}{g}_{11} & {g}_{12} & {g}_{13} & {g}_{14} \\ {g}_{21} & {g}_{22} & {g}_{23} & {g}_{24} \\ {g}_{31} & {g}_{32} & {g}_{33} & {g}_{34} \\ {g}_{41} & {g}_{42} & {g}_{43} & {g}_{44} \\ {g}_{51} & {g}_{52} & {g}_{53} & {g}_{54} \\ {g}_{61} & {g}_{62} & {g}_{63} & {g}_{64} \\ {g}_{71} & {g}_{72} & {g}_{73} & {g}_{74} \\ {g}_{81} & {g}_{82} & {g}_{83} & {g}_{84}\end{matrix} ] = [ \begin{matrix}\underline{35} & 15 & 20 & 0 \\ 30 & 10 & 25 & 5 \\ 25 & 5 & 30 & 10 \\ 20 & 0 & \underline{35} & 15 \\ 15 & \underline{35} & 0 & 20 \\ 10 & 30 & 5 & 25 \\ 5 & 25 & 10 & 30 \\ 0 & 20 & 15 & \underline{35}\end{matrix} ] \qquad ( Equation 1 )$$

If UE 1 is chosen as a certain UE, an AP with the largest large-scale channel gain of 35 for UE 1 is g¹¹. Thus, AP 1 is selected.

When the UEs are sorted in descending order according to the large-scale channel gain of the selected AP 1, they are ranked in the order of “1→3→2→4”. In this case, it is assumed that τₚ is 2. Thus, for AP 1, UE 1 and UE 3 constitute a high-ranked group, and UE 2 and UE 4 constitute a low-ranked group. Orthogonal pilot sequences 0 and 1 are allocated to UE 2 and UE 4 included in the low-ranked group, respectively.

The reusability of pilots between UE 1 in the high-ranked group and UE 2 in the low-ranked group is computed, and the reusability of pilots between UE 1 in the high-ranked group and UE 4 in the low-ranked group is computed. For AP 1 which has the largest large-scale channel gain for UE 1, the reusability of pilots between UE 1 and UE 2 is computed to be 20, and the reusability of pilots between UE 1 and UE 4 is computed to be 35.

Likewise, the pilot reusability for UE 3 in the high-ranked group is computed in the same manner. For AP 4 which has the largest large-scale channel gain for UE 3, the reusability of pilots between UE 3 and UE 2 is computed to be 35, and the reusability of pilots between UE 3 and UE 4 is computed to be 20.

To sum up, the reward matrix may be formulated as in Table 1.

TABLE 1

| | UE 2 | UE 4 |
|---|---|---|
| UE 1 | 20 | 35 |
| UE 3 | 35 | 20 |

A maximum-weight matching is found by applying the Hungarian algorithm to the reward matrix shown in Table 1. Thus, interference between UEs can be minimized when UE 1 is assigned the same pilot (co-pilot) as UE 4 and UE 3 is assigned the same pilot as UE 2. The same applies when choosing UE 2, UE 3, or UE 4 as a certain UE and finding an optimum co-pilot allocation. That is, interference between UEs can be minimized when UE 1 is assigned the same pilot as UE 4 and UE 3 is assigned the same pilot as UE 2.

At least some of the components described in the exemplary embodiments of the present disclosure may be implemented as hardware elements including at least one or a combination of a digital signal processor (DSP), a processor, a controller, an application-specific IC (ASIC), a programmable logic device (FPGA, etc.), and other electronic devices. In addition, at least some of the functions or processes described in the exemplary embodiments may be implemented as software, and the software may be stored in a recording medium. At least some of the components, functions, and processes described in the exemplary embodiments of the present disclosure may be implemented through a combination of hardware and software.

The methods according to the exemplary embodiments of the present disclosure may be written as a program that can be executed on a computer, and may also be implemented in various recording mediums such as a magnetic storage medium, an optical read medium, and a digital storage medium.

Implementations of the various techniques described herein may be realized by digital electronic circuitry, or by computer hardware, firmware, software, or combinations thereof. Implementations may be made as a computer program tangibly embodied in a computer program product, i.e., an information carrier, e.g., machine-readable storage device (computer-readable medium) or a radio signal, for processing by, or controlling the operation of a data processing device, e.g., a programmable processor, a computer, or multiple computers. Computer programs, such as the computer program(s) described above, may be written in any form of programming language, including compiled or interpreted languages, and may be deployed in any form as a stand-alone program or as a module, component, subroutine, or other units suitable for use in a computing environment. The computer program may be processed on one computer or multiple computers at one site or distributed across multiple sites and developed to be interconnected through a communications network.

Processors suitable for processing computer programs include, by way of example, both general-purpose and special-purpose microprocessors, and any one or more processors of any type of digital computer. Typically, a processor will receive instructions and data from read-only memory or random access memory, or both. Elements of the computer may include at least one processor that executes instructions and one or more memory devices that store instructions and data. In general, the computer may include one or more mass storage devices that store data, such as magnetic disks, magneto-optical disks, or optical disks, or may be coupled to the mass storage devices to receive data therefrom and/or transmit data thereto. Information carriers suitable for embodying computer program instructions and data include, for example, semiconductor memory devices, magnetic mediums such as hard disks, floppy disks, and magnetic tapes, optical mediums such as CD-ROM (Compact Disk Read Only Memory), DVD (Digital Video Disk), magneto-optical mediums such as floptical disk, ROM (Read Only Memory), RAM (Random Access Memory), flash memory, EPROM (Erasable Programmable ROM), and EEPROM (Electrically Erasable Programmable ROM). The processor and memory may be supplemented by or included in special purpose logic circuitry.

The processor may execute an operating system and software applications executed on the operating system. In addition, the processor device may access, store, manipulate, process, and generate data in response to the execution of software. For ease of understanding, the processor device may be described as being used as a single processor device, but those skilled in the art will understand that the processor device may include a plurality of processing elements and/or a plurality of types of processing elements. For example, a processor device may include a plurality of processors or one processor, and one controller. Further, other processing configurations, such as parallel processors, are also possible.

In addition, a non-transitory computer-readable medium may be any available medium that can be accessed by a computer and may include both a computer storage medium and a transmission medium.

The present specification includes details of a number of specific implements, but it should be understood that the details do not limit any invention or what is claimable in the specification but rather describe features of the specific example embodiment. Features described in the specification in the context of individual example embodiments may be implemented as a combination in a single example embodiment. In contrast, various features described in the specification in the context of a single example embodiment may be implemented in multiple example embodiments individually or in an appropriate sub-combination. Furthermore, the features may operate in a specific combination and may be initially described as claimed in the combination, but one or more features may be excluded from the claimed combination in some cases, and the claimed combination may be changed into a sub-combination or a modification of a sub-combination.

Similarly, even though operations are described in a specific order on the drawings, it should not be understood as the operations needing to be performed in the specific order or in sequence to obtain desired results or as all the operations needing to be performed. In a specific case, multitasking and parallel processing may be advantageous. In addition, it should not be understood as requiring a separation of various apparatus components in the above described example embodiments in all example embodiments, and it should be understood that the above-described program components and apparatuses may be incorporated into a single software product or may be packaged in multiple software products.

It should be understood that the example embodiments disclosed herein are merely illustrative and are not intended to limit the scope of the invention. It will be apparent to one of ordinary skill in the art that various modifications of the example embodiments may be made without departing from the spirit and scope of the claims and their equivalents.

Accordingly, one of ordinary skill would understand that the scope of the claimed invention is not to be limited by the above explicitly described embodiments but by the claims and equivalents thereof.

What is claimed is:

1. A method for allocating pilots by using the Hungarian algorithm in a cell-free massive MIMO system, the method comprising:
obtaining a first matrix by computing a large-scale channel gain between each of a plurality of UEs and each of a plurality of APs included in the cell-free massive MIMO system;
assigning each of the plurality of UEs to a first group or a second group by using the first matrix;
allocating a pilot to each UE in the second group;
obtaining a second matrix by computing the reusability of pilots between each UE in the first group and each UE in the second group; and
allocating a pilot to each UE in the first group by applying the Hungarian algorithm to the second matrix.

2. The method of claim 1, wherein the assigning comprises:
choosing a certain UE from among the plurality of Ues,
selecting an AP with the largest large-scale channel gain for the chosen UE by using the first matrix, and
assigning the each of the plurality of UEs to the first group or the second group based on the large-scale channel gain for the selected AP.

3. The method of claim 1, wherein the assigning comprises:
choosing a certain UE from among the plurality of UEs, and selecting an AP with the largest large-scale channel gain for the chosen UE by using the first matrix;
sorting the plurality of UEs in descending order according to the large-scale channel gain for the selected AP; and
assigning as many UEs as the number of orthogonal pilots to the first group, including the chosen UE, in the order of largest to smallest large-scale channel gain, and assigning the other UEs to the second group.

4. The method of claim 3, wherein, in the allocating of a pilot to each UE in the second group, the orthogonal pilots are sequentially allocated to the UEs in the second group.

5. The method of claim 1, wherein, in the obtaining of a second matrix, the second matrix is obtained by finding an AP with the largest large-scale channel gain for each UE in the first group and computing the reusability of pilots between the UE and each UE in the second group for the found AP.

6. The method of claim 1, wherein the pilot reusability is computed based on a difference in large-scale channel gain between the UE and each UE in the second group.

7. The method of claim 1, wherein the allocating of a pilot to each UE in the first group includes:
matching one of the UEs in the second group with each UE in the first UE by applying the Hungarian algorithm to the second matrix; and
allocating the same pilot as that of the matched UE in the second group to the corresponding UE in the first group.

8. The method of claim 7, wherein, in the matching, a UE with the highest pilot reusability among the UEs in the second group is matched with each UE in the first group.

9. A computer-readable recording medium with instructions stored therein, wherein the instructions, when executed by the computer, cause the computer to implement a method comprising:
obtaining a first matrix by computing a large-scale channel gain between each of a plurality of UEs and each of a plurality of APs included in the cell-free massive MIMO system;
assigning each of the plurality of UEs to a first group or a second group by using the first matrix;
allocating a pilot to each UE in the second group;
obtaining a second matrix by computing the reusability of pilots between each UE in the first group and each UE in the second group; and
allocating a pilot to each UE in the first group by applying the Hungarian algorithm to the second matrix.
